(19) United States
(12) Patent Application Publication
(10) Pub. No.: US 2015/0083834 A1
(43) Pub. Date: Mar. 26, 2015

(54) REDUCING TWINE WRAP ON BALE PROCESSOR SHAFTS

(71) Applicant: Highline Manufacturing Ltd, Vonda (CA)

(72) Inventors: Blake Neudorf, Vonda (CA); Joel Dokken, Vonda (CA); Justin Regier, Vonda (CA); Ashley Medernach, Vonda (CA)

(73) Assignee: Highline Manufacturing Ltd, Vonda (CA)

(21) Appl. No.: 14/032,564

(22) Filed: Sep. 20, 2013

(51) Int. Cl. A01F 29/10; A01F 29/04; A01F 29/00

(52) U.S. Cl. CPC A01F 29/10; A01F 29/005; A01F 29/04
USPC 241/30; 241/280; 241/166

(57) ABSTRACT

Wrapping of twine on a chain and slat conveyor in a bale processor is reduced. The bale processor has a bale chamber, a chain bed forming a bottom of the bale chamber and a disintegrator roller mounted along one side. Driven and idler shafts extend adjacent to opposite first and second sides of the chain bed. Front, middle, and rear sprockets are mounted to front, middle, and rear portions of the shafts, and corresponding front, middle, and rear conveyor chains engage corresponding sprockets. Conveyor slats are attached to the chains. Wrapping of twine is reduced by supporting the shafts only at front and rear ends thereof such that the sprockets and shafts rotate unsupported between front and rear bearings on walls of the bale chamber. Scraper devices can be mounted adjacent to front and rear sprockets to prevent the build-up of twine on the shafts.

This invention is in the field of agricultural bale processors for shredding baled crop material and in particular an apparatus for reducing the occurrence of twine wrapping on sprocket shafts of a bale drive chain in a bale processor.

### BACKGROUND

In the livestock industry, large bales of crop material are formed and tied with twine, and then stored for use. Commonly a bale processor is then used to shred the bales and distribute the shredded material for feed and/or bedding. Such bale processors typically have a disintegrator roller longitudinally mounted for rotation inside a processing chamber. The disintegrator roller is rotated, and flails on the roller extend to engage a bale in the processing chamber, remove and shred material from the bale, and discharge the shredded material out of the processing chamber.

As material is removed from the bale, the bale gets smaller and so bale processors must include some mechanism for pushing the bale toward the disintegrator roller such that same continues to engage the flails. In one common type of bale processor, the disintegrator roller extends along one side of the bale chamber, and the bale rests on a chain and slat conveyor that extends the length of the bale chamber and moves laterally across the chamber moving the bale into the flails. Such chain and slat conveyor bale processors are disclosed for example in U.S. Pat. No. 5,368,238 to Bergkamp et al. and in U.S. Pat. No. 5,090,630 to Kopecky et al.

The chain and slat conveyor comprises commonly a driven shaft extending along one side of the bale chamber and an idler shaft extending parallel along the opposite side. Either the idler or driven shafts is mounted adjacent to the disintegrator roller, with the other shaft at the opposite side of the bale chamber. One of the shafts is movable to adjust chain tension. The conveyor comprises parallel slats extending the length of the bale chamber and fastened to chains which engage sprockets attached to the driven and idler shafts such that rotating the driven shaft moves the slats, and the bale resting thereon, toward the disintegrator roller. The floor of bale chamber is provided by a chain bed, and the slats and chains move toward the disintegrator roller across the top surface of the chain bed such that the bale is supported on the chain bed, and the return run of the conveyor is under the chain bed

Due to the length of the bale chamber and weight of the bale, three chains spaced apart at the front, middle, and rear of the bale chamber are conventionally used to support the slats and prevent bending thereof. Each of the idler and driven shafts thus has corresponding front, middle, and rear sprockets mounted thereon. The idler and driven shafts are supported on front, middle, and rear bearings which are located adjacent to the corresponding front, middle, and rear sprockets. The front and rear bearings are conveniently attached to the front and rear walls of the bale chamber, and the middle bearings are fixed to the chain bed. It is also known to rotatably mount three separate idler sprockets independently on separate front, middle, and rear bearings fixed to the bale chamber walls or the chain bed, such that there is no idler shaft as such.

Such chain and slat conveyors provide a simple and economical mechanism for moving the bale against the disintegrator roller, however a problem with the system is that the bales are shredded without removing the twine. Loose twine is thus always present in the bale chamber, and wraps around the driven and idler shafts adjacent to the sprockets and bearings, and between the chain and the sprockets. This twine must be removed periodically to prevent damage.

### SUMMARY OF THE INVENTION

It is an object of the present invention to provide a chain and slat conveyor apparatus for a bale processor that overcomes problems in the prior art.

In a first embodiment the present invention provides a bale processor apparatus comprising a bale chamber, and a chain bed forming a bottom of the bale chamber. A disintegrator roller is rotatably mounted along a length of one side of the bate chamber. A driven shaft extends adjacent to a first side edge of the chain bed and front, middle, and rear drive sprockets are mounted to front, middle, and rear portions of the driven shaft. An idler shaft extends adjacent to a second side edge of the chain bed, and front, middle, and rear idler sprockets are mounted to front, middle, and rear portions of the idler shaft. The driven and idler shafts are supported only at front and rear ends thereof by corresponding front and rear bearings such that the sprockets and shafts rotate unsupported between the front and rear bearings such that twine wrapping on middle portions of the driven and idler shafts is reduced. Front, middle, and rear conveyor chains, each engage corresponding front, middle, and rear drive and idler sprockets such that a top run of each chain extends along a top surface of the chain bed and a return run of each chain extends under the chain bed. A plurality of conveyor slats are oriented substantially parallel to the driven and idler shafts and attached to the front, middle, and rear chains.

In a second embodiment the present invention provides a method of reducing the wrapping of twine on a chain and slat conveyor in a bale processor, the bale processor comprising a bale chamber; a chain bed forming a bottom of the bale chamber; a disintegrator roller rotatably mounted along a length of one side of the bale chamber; a driven shaft extending adjacent to a first side edge of the chain bed; front, middle, and rear drive sprockets mounted to front, middle, and rear portions of the driven shaft; an idler shaft extending adjacent to a second side edge of the chain bed; front, middle, and rear idler sprockets mounted to front, middle, and rear portions of the idler shaft; front, middle, and rear conveyor chains, each chain engaging corresponding front, middle, and rear drive and idler sprockets such that a top run of each chain extends along a top surface of the chain bed and a return run of each chain extends under the chain bed; and a plurality of conveyor slats oriented substantially parallel to the driven and idler shafts and attached to the front, middle, and rear chains. The method comprises supporting the driven and idler shafts only at front and rear ends thereof with corresponding front and rear bearings such that the sprockets and shafts rotate unsupported between the front and rear bearings and twine wrapping on middle portions of the driven and idler shafts is reduced.

Scraper devices can be mounted adjacent o front and rear sprockets to prevent he build-up of twine on the shafts.

The apparatus and method of the present invention thus reduce wrapping of twine on the chain and slat conveyor of a bale processor. Time and effort needed to remove twine is reduced, and the risk of damage from wrapped twine is reduced as well.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic top view of an embodiment of a bale processor apparatus of the present invention, with the chains and slats removed to more clearly show the apparatus;

FIG. 2 is a schematic top view of the embodiment of Fig. with the chains and slats installed;

FIG. 3 is a schematic op view of an idler shaft of the prior art;

FIG. 4 is a schematic detail top view of the front end of e idler shaft of the embodiment of FIG. 1;

FIG. 5 is a schematic detail front view of the front end of an alternate configuration of the front end of an idler shaft that could be used in the embodiment of FIG. 1;

FIG. 6 is a schematic sectional end view of the idler shaft of FIG. 5.

### DETAILED DESCRIPTION OF THE ILLUSTRATED EMBODIMENTS

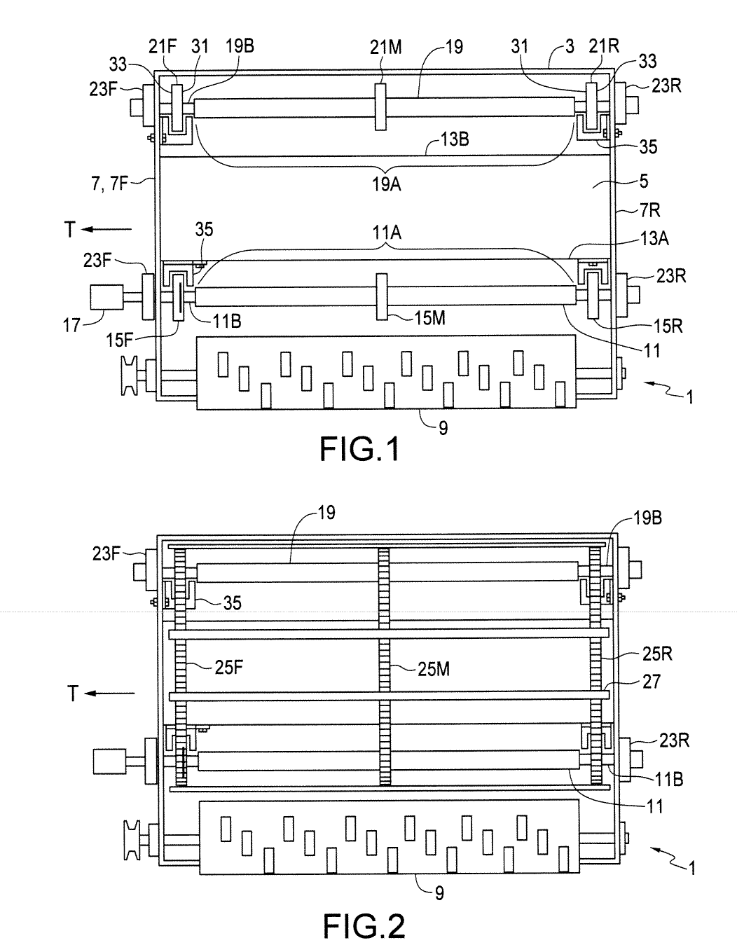

FIGS. 1 and 2 schematically illustrate an embodiment of a bale processor apparatus 1 of the present invention. The apparatus 1 comprises a bale chamber 3, and a chain bed 5 forming a bottom of the bale chamber 3. The bale chamber 3 is typically mounted on wheels for movement along the ground in an operating travel direction T. A disintegrator roller 9 is rotatably mounted along a length of one side of the bale chamber 3. The disintegrator roller 9 is illustrated on the left side but could also be on the right side. The front and rear ends of the chain bed 5 are attached to front and rear walls 7F, 7R of the bale chamber 3 such that an open space is created under the chain bed 5 for passage of a chain and slat conveyor that continuously moves a bale of crop material toward the disintegrator roller 9.

The chain and slat conveyor comprises a driven shaft 11 extending adjacent to a first side edge 13A of the chain bed 5, and front, middle, and rear drive sprockets 15F, 15M, 15R mounted to front, middle, and rear portions of the driven shaft 11. The drive shaft is driven by a hydraulic motor 17, or like drive mechanism.

An idler shaft 19 extends adjacent to a second side edge 13B of the chain bed 5, and front, middle, and rear idler sprockets 21F, 21M, 21R are mounted to front, middle, and rear portions of the idler shaft 19. The driven and idler shafts 11, 19 are supported only at front and rear ends thereof by corresponding front and rear bearings 23F, 23R such that the sprockets 15, 17 and shafts 11, 19 rotate unsupported between the front and rear bearings 23F, 23R such that twine wrapping on middle portions of the driven and idler shafts 11, 19 is reduced.

Front, middle, and rear conveyor chains 25F, 25M, 25R each engage corresponding front, middle, and rear drive and idler sprockets 15, 21 such that a top run of each chain 25, visible in FIG. 2, extends along a top surface of the chain bed 5 and a return run of each chain extends under the chain bed 5. A plurality of conveyor slats 27 are oriented substantially parallel to the driven and idler shafts 11, 19 and are attached to the front, middle, and rear chains 25F, 25M, 25R as is known in the art. The chains 25 and slats 27 are shown in FIG. 2 but have been deleted from FIG. 1 to more clearly show the apparatus 1.

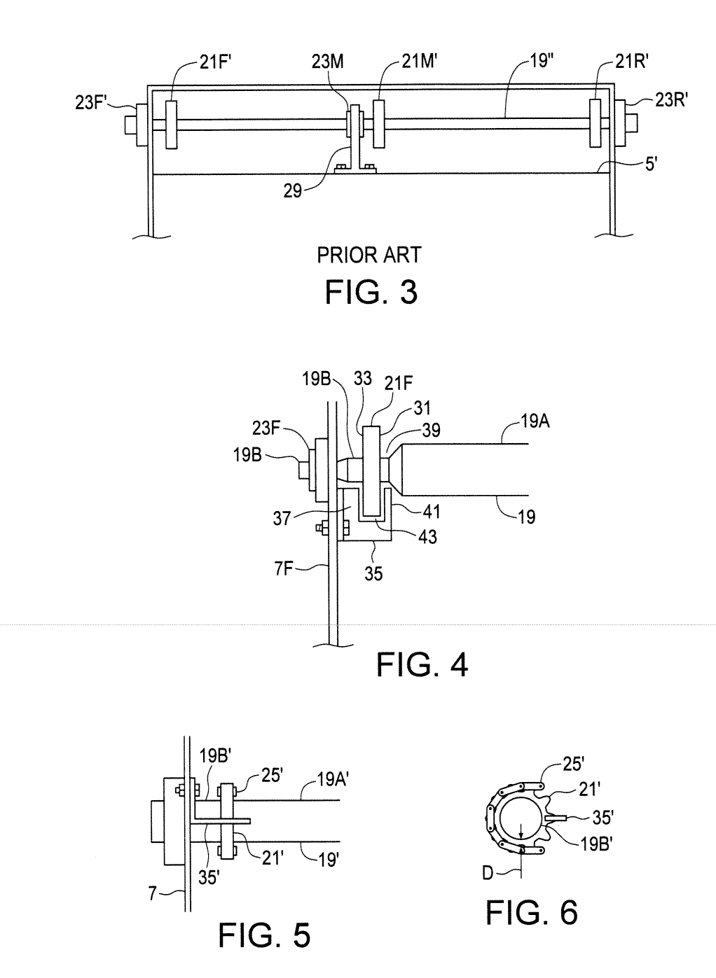

An idler shaft 19′ of the prior art is schematically illustrated in FIG. 3 with front, middle, and rear idler sprockets 21F′, 21M′, 21R′ mounted to front, middle, and rear portions of the idler shaft 19′. The prior art idler shaft 19′ is supported at front and rear ends thereof in front and rear bearings 23F′, 23R′ and in addition is supported at a mid-point near the middle idler sprocket 21M′ by a middle bearing 23M shown mounted on a bracket 29 fixed to the chain bed 5′. Twine being carried over the rotating middle idler sprocket 21M′ contacts the middle bearing, the bracket 29, and protrusions thereon such as bolt heads, etc. and tends to catch and wrap around the idler shaft as the shaft continues rotating while the twine is held stationary by the fixed bracket 29 and bearing 21M′. The driven shafts of the prior art are similarly supported by a middle bearing.

In contrast in the apparatus 1 of the present invention, there is nothing stationary in the middle of the driven or idler shafts 11, 19 that can obstruct twine and cause same to wrap. Twine being carried over the rotating middle idler sprocket 21M just keeps going, and the occurrence of twine wrapping around the middle portion of the shafts 11, 19 is significantly reduced.

In the prior art the middle bearing is required to support the driven and idler shafts and prevent them from bending under the tension of the middle chain of the chain and slat conveyor. In the present invention such bending is prevented by increasing the size and strength of the shafts instead.

Thus in the apparatus 1 of the present invention, the driven and idler shafts 11, 19 are cylindrical and have a larger first diameter on main portions 11A, 19A thereof extending substantially from inner surfaces 31 of the front sprockets 15F, 21F to inner surfaces 31 of the rear sprockets 15R, 21R mounted thereon, and have a second smaller diameter on end portions 11B, 19B thereof that extend substantially from outer surfaces 33 of the front and rear sprockets 15F, 21F 15R, 21R into the front and rear bearings 23F, 23R.

Wrapping of twine about the middle portions of the shafts 11, 19 is reduced as described above by removing the stationary bearing 23M and bracket 29. At the ends of the shafts 11, 19 however the walls 7F, 7R and bearings 23F, 23R are of course stationary. The front and rear bearings 23F, 23R are mounted on the outside surface of corresponding front and rear walls 7F, 7R of the bale chamber 3 outside the bale chamber 3 to reduce Obstructions on the inner surfaces of the walls 7F, 7R. The end portions 11B, 19B of the driven and idler shafts 11, 19 extend through holes in the front and rear walls 7F, 7R and into the front and rear bearings 23F, 23R.

To further reduce wrapping of twine around the shafts 11, 19, in the apparatus 1 of the present invention a scraper device 35 is mounted at each end of the shafts 11, 19. FIG. 4 schematically illustrates the scraper device 35 at the front end of the idler shaft 19 which is configured and mounted such that an outer scraping projection 37 thereof extends between the inside surface of the front wall 7F and the outer surface 33 of the adjacent front idler sprocket 21F such that an end edge of the outer scraping projection 37 is in proximity to the end portion 19B of the shaft 19 carrying the sprocket 21F, and side edges of the outer scraping projection 37 are in proximity to the inside surface of the front wall and the outer surface 33 of the sprocket 21F.

In the illustrated apparatus 1 the diameter of the idler shaft 19 is reduced adjacent to the inner surface 33 of the sprocket 21F such a that a recess 39 is formed. The scraper device 35 also has an inner scraping projection 41 separated from the outer scraping projection 37 by a gap 43 configured to allow the sprocket 21F to rotate in the gap 43. The inner scraping projection 41 extends into the recess 39 with edges thereof in proximity to the inner surface 31 of the sprocket 21F and the shaft 19.

Thus as the shaft 19 rotates, twine may begin to gather adjacent to the stationary walls 7 however the outer and inner scraping projections 37, 41 prevent same from building up, and thus reduce twine wrapping.

In the illustrated apparatus 1, the idler shaft 19 and associated front and rear bearings 23F, 23R are mounted in slots through the front and rear walls 7F, 7R so that the shaft and bearings can be moved to adjust chain tension. The scraper devices 35 related to the movable idler shaft 19 are therefore also adjustable, for example as shown attached by bolts through slots in the walls 7 as well such that the close relationship between the outer and inner scraping projections 37, 41 and the sprocket 21F and shaft 19 can be maintained. The driven shaft 11 is fixed, and so the scraper devices 35 related thereto can be attached to the fixed chain bed

FIGS. 5 and 6 schematically illustrate front and side views of an alternate configuration of the end of the idler shaft 19′ where the end portions 19B′ have the same increased diameter as the main portion 19A′. In the configuration of FIGS. 5 and 6, the distance D between the bottom of the links of the chain 25′ that is engaged on sprocket 21′ and the outer surface of the shaft 19B is reduced, leaving less space for twine to gather. A scraper device 35′ is shown attached to the wall 7.

The invention thus provides a method of reducing the wrapping of twine on a chain and slat conveyor in a bale processor by supporting the driven and idler shafts 11, 19 only at front and rear ends thereof with corresponding front and rear bearings 23F, 23R such that the sprockets 15, 21 and shafts 11, 19 rotate unsupported between the front and rear bearings. To prevent bending of the shafts 11, 19 the cross-sectional area of at least the main portion 11A, 19A of the driven and idler shafts is increased to increase the bending resistance thereof. Alternately the entire length of the shafts can be increased as schematically illustrated in FIG. 5.

The method further comprises mounting a scraper device 35 such that an outer scraping projection 37 thereof extends between an inside surface of one of the front and rear walls 7 and the outer surface 33 of an adjacent sprocket 15, 21 such that an end edge of the outer scraping projection 37 is in proximity to the shaft 11, 19 carrying the sprocket. The side edges of the outer scraping projection 37 are in proximity to the inside surface of the wall 7 and the outer surface 33 of the adjacent sprocket.

An inner scraping projection 41 is also provided on the scraper device 35 separated from the outer scraping projection 37 by a gap 43 configured to allow the adjacent sprocket 15, 21 to rotate in the gap. An end edge of the inner scraping projection 41 is in proximity to the shaft carrying the adjacent sprocket and a side edge of the inner scraping projection 41 is in proximity to the inner surface 31 of the adjacent sprocket.

The apparatus and method of the present invention thus reduce wrapping of twine on the chain and slat conveyor of a bale processor. Time and effort needed to remove twine is reduced, and the risk of damage from wrapped twine is reduced as well.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A bale processor apparatus comprising:
a bale chamber, and a chain bed forming a bottom of the bale chamber;
a disintegrator roller rotatably mounted along a length of one side of the bale chamber;
a driven shaft extending adjacent to a first side edge of the chain bed;
front, middle, and rear drive sprockets mounted to front, middle, and rear portions of the driven shaft;
an idler shaft extending adjacent to a second side edge of the chain bed;
front, middle, and rear idler sprockets mounted to front, middle, and rear portions of the idler shaft;
wherein the driven and idler shafts are supported only at front and rear ends thereof by corresponding front and rear bearings such that the sprockets and shafts rotate unsupported between the front and rear bearings such that twine wrapping on middle portions of the driven and idler shafts is reduced;
front, middle, and rear conveyor chains, each chain engaging corresponding front, middle, and rear drive and idler sprockets such that a top run of each chain extends along a top surface of the chain bed and a return run of each chain extends under the chain bed;
a plurality of conveyor slats oriented substantially parallel to the driven and idler shafts and attached to the front, middle, and rear chains.

2. The apparatus of claim 1 wherein the driven and idler shafts are substantially cylindrical and have a first diameter on main portions thereof extending substantially from inner surfaces of the front sprockets to inner surfaces of the rear sprockets mounted thereon, and have a second smaller diameter on end portions thereof that extend substantially from outer surfaces of the front and rear sprockets into the front and rear bearings.

3. The apparatus of claim 1 wherein the front and rear bearings on at least one of the driven and idler shafts are mounted on an outside surface of corresponding front and rear walls of the bale chamber outside the bale chamber, and wherein the end portions of the at least one of the driven and idler shafts extend through holes in the front and rear walls and into the corresponding front and rear bearings.

4. The apparatus of claim 3 comprising at least one scraper device mounted such that an outer scraping projection thereof extends between an inside surface of one of the front and rear walls and the outer surface of an adjacent sprocket such that an end edge of the outer scraping projection is in proximity to the end portion of the shaft carrying the sprocket.

5. The apparatus of claim 4 wherein the outer scraping projection is configured such that side edges of the outer scraping projection are in proximity to the inside surface of the one of the front and rear walls and the outer surface of the adjacent sprocket.

6. The apparatus of claim 5 wherein a diameter of the shaft carrying the sprocket is reduced adjacent to the inner surface of the sprocket such a that a recess is formed, and wherein the scraper device comprises inner and outer scraping projections separated by a gap configured to allow the sprocket to rotate in the gap, and wherein the inner scraping projection extends into the recess with edges thereof in proximity to the inner surface of the sprocket and the shaft.

7. The apparatus of claim 4 wherein the at least one scraper device is mounted to one of the inside surface of the one of the front and rear walls and the chain bed.

8. A method of reducing the wrapping of twine on a chain and slat conveyor in a bale processor, the bale processor comprising a bale chamber; a chain bed forming a bottom of the bale chamber; a disintegrator roller rotatably mounted along a length of one side of the bale chamber; a driven shaft extending adjacent to a first side edge of the chain bed; front, middle, and rear drive sprockets mounted to front, middle, and rear portions of the driven shaft; an idler shaft extending adjacent to a second side edge of the chain bed; front, middle, and rear idler sprockets mounted to front, middle, and rear portions of the idler shaft; front, middle, and rear conveyor chains, each chain engaging corresponding front, middle, and rear drive and idler sprockets such that a top run of each chain extends along a top surface of the chain bed and a return run of each chain extends under the chain bed; and a plurality of conveyor slats oriented substantially parallel to the driven and idler shafts and attached to the front, middle, and rear chains; the method comprising supporting the driven and idler shafts only at front and rear ends thereof with corresponding front and rear bearings such that the sprockets and shafts rotate unsupported between the front and rear bearings and twine wrapping on middle portions of the driven and idler shafts is reduced.

9. The method of claim 8 comprising increasing a cross-sectional area of at least a portion of the driven and idler shafts.

10. The method of claim 8 comprising mounting at least one scraper device such that an outer scraping projection thereof extends between an inside surface of one of the front and rear walls and the outer surface of an adjacent sprocket such that an end edge of the outer scraping projection is in proximity to the shaft carrying the sprocket.

11. The method of claim 10 comprising configuring the outer scraping projection such that side edges of the outer scraping projection are in proximity to the inside surface of the one of the front and rear walls and the outer surface of the adjacent sprocket.

12. The method of claim 11 comprising providing an inner scraping projection on the scraper device separated from the outer scraping projection by a gap configured to allow the adjacent sprocket to rotate in the gap, and mounting the scraper device such that an end edge of the inner scraping projection is in proximity to the shaft carrying the adjacent sprocket and a side edge of the inner scraping projection is in proximity to the inner surface of the adjacent sprocket.
